(19) United States
(12) Patent Application Publication
(10) Pub. No.: US 2026/0140815 A1
(43) Pub. Date: May 21, 2026

(54) Automated Log Collection and Analysis to Remediate User Experience Issues

(71) Applicant: Zscaler, Inc., San Jose, CA (US)

(72) Inventors: Tejas Budukh, Fremont, CA (US); Prasanna Jobigenahally Malleshaiah, Sunnyvale, CA (US); Saroj Kumar Panigrahy, Fremont, CA (US); Satish Kalipatnapu, Alpharetta, GA (US); Subhro Jyoti Roy, Santa Clara, CA (US)

(73) Assignee: Zscaler, Inc., San Jose, CA (US)

(21) Appl. No.: 19/053,716

(22) Filed: Feb. 14, 2025

Related U.S. Application Data
(63) Continuation-in-part of application No. 18/953,336, filed on Nov. 20, 2024.

(51) Int. Cl. G06F 11/07

(52) U.S. Cl. CPC G06F 11/0793; G06F 11/0766

(57) ABSTRACT

Systems and methods are provided for automatically supporting clients in a help desk framework. In one implementation, a method includes a step of monitoring an enterprise network. In response to detecting one or more adverse conditions of the enterprise network that imply a decline in one or more User Experience (UX) metrics, the method further includes a step of automatically collecting data logs from the enterprise network. Also, the method includes automatically analyzing the data logs. In response to determining that the data logs indicate one or more issues in the enterprise network, the method further includes a step of suggesting actions to remediate the one or more issues.

### CROSS REFERENCE TO RELATED APPLICATION

The present application is a Continuation-in-Part (CIP) application of and claims the benefit of priority to U.S. patent application Ser. No. 18/953,336, filed Nov. 20, 2024, entitled “Automated Workflow Management and Solution Recommendation in Customer Support Ticketing System,” the contents of which are incorporated by reference herein.

### TECHNICAL FIELD

The present disclosure generally relates to cloud-based customer support systems. More particularly, the present disclosure relates to automated ticketing systems configured to automatically retrieve data logs based on specific triggers to remediate user experience issues.

### BACKGROUND

Generally, customer support teams manage a high volume of customer service tickets daily. For example, in a cybersecurity environment, trust entities may handle tickets involving recurring issues related to network congestion, downtime, authentication challenges, policy misconfigurations, among others. Addressing these issues currently requires multiple customer interactions, manual searches through past tickets, and heavy reliance on the experience of individual support agents. This manual approach increases the time required to resolve issues and limits the consistency and efficiency of customer support services.

### BRIEF SUMMARY

The present disclosure is directed to ticketing systems and processing customer service tickets. A method for implementing an automated help desk is provided in order to remediate User Experience (UX) issues or other adverse conditions in an enterprise network. According to some implementations, the method includes a step of monitoring an enterprise network. In response to detecting one or more adverse conditions of the enterprise network that imply a decline in one or more UX metrics, the method includes a step of automatically collecting data logs from the enterprise network. Next, the method includes a step of automatically analyzing the data logs. In response to determining that the data logs indicate one or more issues in the enterprise network, the method includes a step of suggesting actions to remediate the one or more issues.

According to some embodiments, the method may further include a step of generating one or more insights or recommendations for consideration by a help desk agent. The step of automatically collecting data logs, for example, may be automatically triggered by a detected decline in the one or more UX metrics or specific adverse conditions in the enterprise network. In some embodiments, an action of searching for one or more adverse conditions of the enterprise network may include a step of monitoring device events of one or more end user devices incorporated in the enterprise network.

The method, in some implementations, may also include a step of preemptively collecting data logs before opening a service ticket. The method may also include a step of determining whether the one or more adverse conditions of the enterprise network are a root cause of the decline in the one or more UX metrics. The one or more adverse conditions, for example, may include a) a drop in application performance with respect to one or more end user devices associated with the enterprise network, b) recurring connectivity issues with respect to the one or more end user devices, and/or c) a deviation of the one or more end user devices from normal device behavior. In some embodiments, each data log may have a depth that corresponds to a severity of an adverse condition of the enterprise network.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a ticketing system for processing customer service tickets using Large Language Models (LLMs), according to various embodiments.

FIG. 2 is a block diagram illustrating another ticketing system using an LLM, according to various embodiments.

FIG. 3 is a block diagram illustrating a computing system of a ticketing platform, according to various embodiments.

FIG. 4 is a screenshot showing an example of partial summaries of a customer service ticket, according to various embodiments.

FIG. 5 is a screenshot showing a final summary of the example of FIG. 4, according to various embodiments.

FIG. 6 is a screenshot showing an entry field and summary in a chatbot application platform, according to various embodiments.

FIG. 7 is a flow diagram illustrating a method for utilizing LLMs for processing a customer service ticket, according to various embodiments.

FIG. 8A is a network diagram of a cloud-based system or Zero Trust system offering security as a service, according to various embodiments.

FIG. 8B is a diagram of the cloud-based system of FIG. 8A operating as a zero-trust platform, according to various embodiments.

FIG. 8C is a diagram illustrating zero trust policies with the cloud-based system of FIG. 8A and a comparison with a conventional firewall-based approach, according to various embodiments.

FIG. 9 is a diagram illustrating a cloud-based system, according to various embodiments.

FIG. 10 is a network diagram of the cloud-based system in an application of digital experience monitoring, according to various embodiments.

FIG. 11A is diagram illustrating a User Experience (UX) ticketing system, according to various embodiments.

FIG. 11B is a block diagram illustrating the automated client support system shown in FIG. 11A, according to various embodiments.

FIG. 12 is a flow diagram illustrating a method for implementing an automated help desk in order to remediate UX issues or other adverse conditions in an enterprise network, according to various embodiments.

### DETAILED DESCRIPTION

The present disclosure relates to systems and methods associated with customer service or customer support platforms, particularly ticketing systems, for managing tickets regarding issues within a network. As described herein, a “ticket” (e.g., customer service ticket, customer support ticket, and the like) refers to a record of a customer's interaction with a service representative and may be a key part of a business's customer support framework. In the present disclosure, the ticketing systems may be partially or fully automated, thereby reducing or eliminating the responsibilities of the service representative and replacing the human factor in this regard with chatbot systems, Large Language Models (LLMs), Artificial Intelligence (AI) models, Machine Learning (ML) models, etc. For example, cybersecurity entities (e.g., a cloud service provider) may handle multiple tickets every day for resolving security issues and other customer issues that arise during network operation. The embodiments described herein are configured to leverage LLMs to dynamically summarize ticket information.

A customer service ticket may be a formal request from a customer for help with a specific problem, a question regarding network operations (e.g., security applications within a domain), chat queries, problem reporting, etc. With automated assistance, solutions to customer problems may include answers that satisfy the customer's concerns, automated resolutions, network reconfigurations, debugging, measuring, and testing network equipment, and the like. Customer service tickets may be managed by the systems and methods of the present disclosure through a helpdesk-type ticketing system, which can help organizations (e.g., cybersecurity companies) track, monitor, prioritize, and categorize various tickets they receive from their customers. With the assistance of LLMs, the organizations can provide better and faster resolution of customer issues, thereby providing a better customer experience.

### Ticketing Systems

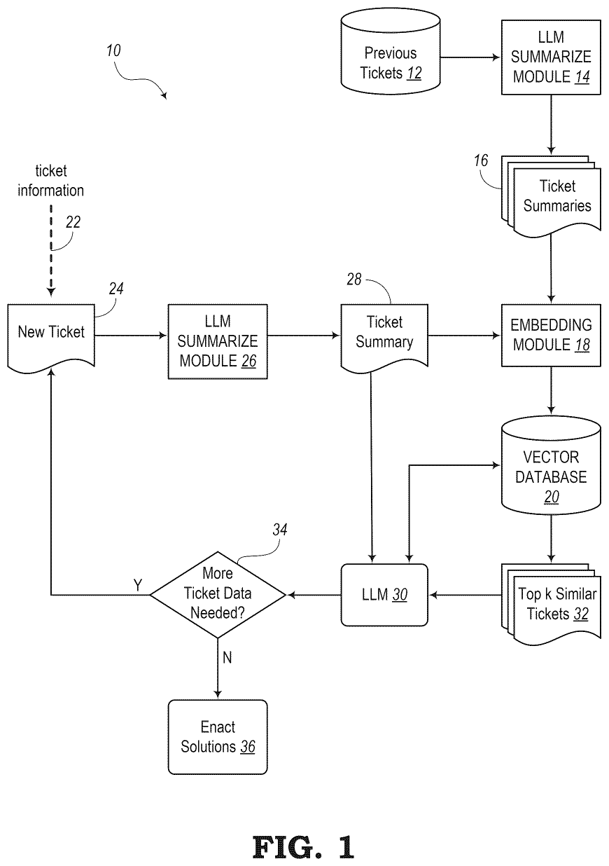

FIG. 1 is a block diagram illustrating an embodiment of a ticketing system 10 for processing customer service tickets using LLMs. As shown in FIG. 1, the ticketing system 10 includes a database 12 that stores previous tickets. For example, the previous tickets may include at least a number of tickets associated with a network domain for which issues (e.g., network issues) have already been resolved. Furthermore, the ticketing system 10 includes an LLM summarize module 14 that is configured to create “summaries” for the previous tickets resulting in ticket summaries 16. For example, summaries may include a short description of the overall issue, a time range during which the issue has occurred, monitoring and testing data of a network domain, a list of organizations, customers, and/or domain devices affected by the issue, information regarding attempts to resolve the issue, root cause analysis, and/or other data associated with the analysis of the issue and resolutions to the issue.

The ticket summaries 16 are applied to an embedding module 18 configured to convert the multi-dimensional features of each ticket summary to a multi-dimensional vector. The vectors are stored in a vector database 20, which is configured to store the multiple vectors associated with previous tickets as wells as continuously add new vectors associated with new tickets to establish a rich base of multiple types of issues that may arise within a domain and how these issues may be resolved.

The ticketing system 10 further includes an entry 22 of new ticket information, which may be obtained via a User Interface (UI) of a user or customer operating on behalf of a specific domain in which an issue is detected. The entry 22 may include information associated with the customer, organization, or domain and information regarding one or more issues, questions, queries, etc. regarding the domain. In some embodiments, new tickets may be opened automatically by domain systems that continuously monitor the customer's domain. In other embodiments, new tickets may be opened using a manual approach.

The new ticket information is used to create a new ticket 24. The ticketing system 10 also includes another LLM summarize module 26, which may be the same as or similar to the LLM summarize module 14. In this case, the LLM summarize module 26 is configured to summarize the information of the new ticket 24 to create a ticket summary 28. In addition, the ticketing system 10 includes an LLM 30 configured to receive data of the ticket summary 28 and process the ticket summary 28. One task of the LLM 30 involves the performance of a similarity search with respect to entries in the vector database 20, which may include providing the data from the ticket summary 28 to the vector database 20 and requesting the top k similar tickets 32 from the vector database 20. From the top k similar tickets 32, the LLM 30 can determine how to handle the current issue, as defined in the ticket summary 28. That is, the same or similar resolution steps taken in one or more previous tickets may also be followed with respect to the new ticket 24.

In some cases, the LLM 30 may determine that more ticket data is needed, as indicated in decision block 34. If so, the ticketing system 10 is configured to return back to an interface associated with the new ticket 24 to request additional information from the original requestor and/or obtain additional parameters from monitoring and telemetry systems associated with the customer domain of concern. In other cases, the LLM 30 may determine that a clear strategy for handling the new ticket 24 can be discovered from similar ticket resolution actions. As such, the LLM 30 may instruct applicable controllers to enact suitable solutions 36 to the domain of concern. For example, some solutions may include automatically modifying network configurations of the customer domain, rerouting or redirecting network traffic, optimizing routes, avoiding faulty nodes, restarting hardware devices and/or software applications, adding networking or processing capabilities, restoring connectivity, etc.

It may be noted that multiple LLMs can be used by the ticketing system 10. In some embodiments, multiple LLMs may be configured to operate in a cooperative manner. In other embodiments, the LLMs may operate independently of each other and/or may interact with each other according to a collaborative plan based on domain-specific policies and functionality.

The ticketing system 10 may be an automated customer support system that integrates domain-specific LLMs and embedding models tailored to a cloud security platform. One general feature of the ticketing system 10 includes “dynamic ticket summarization,” which may include automatically creating a concise summary of each support ticket upon creation. Dynamic ticket summarization may further include real-time updates for continuously updating the new ticket 24 and ticket summary 28 as new information is added. In this way, the new ticket 24 and ticket summary 28 may include comprehensive content, including summaries of domain details (e.g., issue descriptions, actions taken, findings, proposed next steps, etc.).

A second general feature of the ticketing system 10 may include “solution recommendation,” which can be based on historical data. This may include semantic analysis that uses embedding models to process ticket content semantically. Also, solution recommendation may include a similarity search that compares current tickets to historical data stored in the vector database 20. The recommendations, for instance, may suggest solutions that have been effective in resolving similar issues and/or may enact automated resolutions within the domain.

A third general feature of the ticketing system 10 may include “automated action triggering” (as indicated in block 36). The action triggering may be based on comment analysis of the information of the new ticket 24. This may include real-time monitoring to continuously monitor ticket comments for specific keywords, patterns, sentiments, etc. Predefined actions may be automatically triggered, such as requesting diagnostics, suggesting tools, and/or escalating tickets. Also, the ticketing system 10 can provide proactive support to enable timely and appropriate responses without manual intervention, increasing efficiency and customer satisfaction.

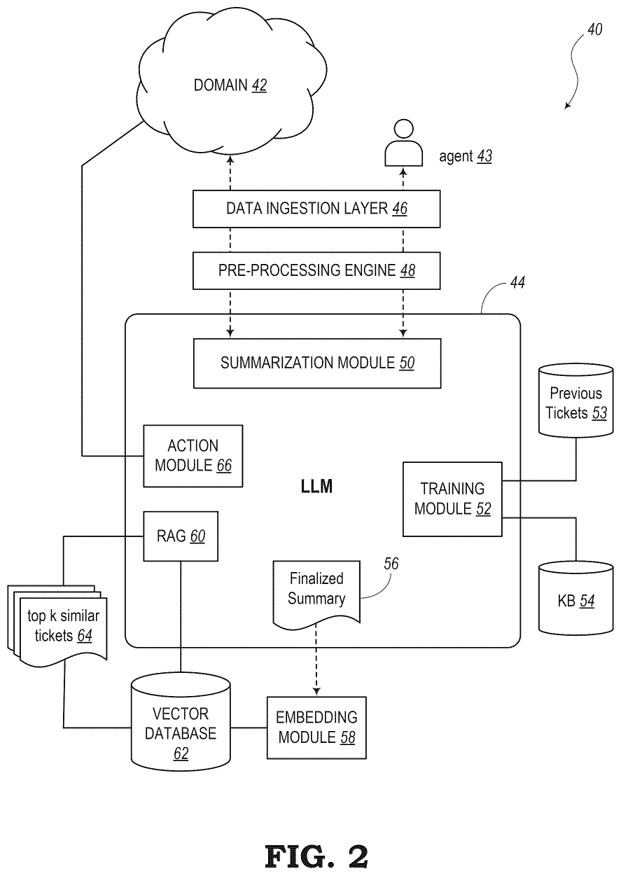

FIG. 2 is a block diagram illustrating another embodiment of a ticketing system 40 using an LLM. As shown in this embodiment, the ticketing system 40 includes a domain 42 or environment that is under observation. The domain 42 may refer to a network or organizational domain associated with a particular enterprise for which a user (e.g., network operator, technician, engineer, admin, etc.) may request the opening of a new ticket. Thus, the domain 42 may include network equipment, switches, routers, end user devices, network monitoring and telemetry systems, control systems, etc. In addition, an agent 43 associated with a cloud-based security entity may further provide manual clarifications, interpretations, input, etc. in addition to the manual or automated data and network metrics provided in the form of ticket information for requesting and defining a new ticket. The input regarding the opening of a new ticket is communicated to an LLM 44 or other cloud-based service system for handling customer service tickets.

The ticketing system 40 includes a data ingestion layer 46 and a pre-processing engine 48, which, in some embodiments, may be part of the LLM 44 or cloud-based ticket processing system. The data ingestion layer 46 may include Natural Language Processing (NLP) systems and devices, chatbot UIs, and other various systems for ingesting new ticket information. The pre-processing engine 48 may include NLP devices, AI models, ML models, etc. for cleaning the ticket information and putting the information into a usable format for suitable processing by the LLM 44. The data ingesting layer 46 and/or pre-processing engine 48 may be configured to pick up specific keywords, patterns, objectives, bullet points, etc.

As shown in FIG. 2, the LLM 44 may include a summarization module 50 configured to receive the ticket information and create a ticket summary of the new ticket opened for one or more specific issues within the domain 42. The LLM 44 may also include a training module 52, which may use AI or ML supervised training techniques. For example, the training module 52 may be configured to obtain data regarding previous tickets stored in a database 53 (e.g., ticket data related to resolved tickets for the domain 42) and may further obtain domain-specific details of the domain 42 as stored in a knowledge base 54. The domain-specific details may include topology information of the domain 42 and policies, standards, and protocols associated with the domain 42. The training module 52 may be configured to train the LLM 44 to enable the LLM 44 to effectively manage new tickets for the domain 42. It should be noted that the LLM 44 may be configured to be trained with respect to any number of domains to allow the processing of tickets for multiple customers or clients.

The LLM 44 may be configured to analyze the new domain-specific ticket information and create an ongoing summary that can be modified dynamically, as described with respect to FIG. 1. The LLM 4 may then produce a finalized summary 56 of the new ticket. The finalized summary 56 can be provided to an embedding module 58. Also, the LLM 44 may include a Retrieval-Augmented Generation (RAG) module 60, which may be configured to access a vector database 62 and retrieve top k similar tickets 64. Also, the embedding module 58 is configured to store vector data of multiple tickets in the vector database 62. The LLM 44 may further include an action module 66 configured to provide control signals to the domain 42 to change configuration tables, reroute transmission paths, or perform other changes to the domain 42 to reduce congestion or traffic, optimize routes, etc. As described with respect to FIG. 1, additional ticket information may be obtained from the domain 42 to modify the finalized summary 56 or an ongoing summary of the ticket.

The data ingestion layer 46 may be configured as an interface for integrating domain-specific data with the LLM 44. The data ingestion layer 46 is configured to be an interface with the LLM 44 of the ticketing system 40 using Application Programming Interfaces (APIs) to retrieve ticket data, including descriptions, comments, and updates. The pre-processing engine 48 may be configured for data cleaning to process and cleanse text data and may include secure privacy compliance in which the pre-processing engine 48 strips sensitive information to maintain compliance with data privacy regulations.

The LLM 44 may be configured as a domain-specific model for one or more domains to provide customized response based on the domain under observation. The training module 52 of the LLM 44 may be configured for customized training, where the LLM 44 can fine-tune the analysis of ticket information based on historical ticket data and domain-specific knowledge. The LLM 44 may also include cloud security proficiency and may specialize in understanding domain-specific terminology. For example, in the realm of cloud-based cybersecurity (e.g., using cloud tools), the LLM 44 may be configured to understand cloud security terminology, recognize common issues with respect to cloud security, and contextualize support requests.

The training and embedding models (e.g., embedding module 18, 58, training module 52, etc.), the ticketing systems 10, 40 may be configured with vector databases 20, 62, etc. for perform nearest neighbor and/or similarity searching to find previously discovered, tried and true solutions to current issues or tickets. The embedding modules 18, 58 may be configured for vector conversion to convert ticket content into numerical vector representations. Then, efficient searches may be conducted with respect to stored vectors in the searchable vector databases 20, 62 for efficient similarity-based solution recommendations. The LLMs may further analyze and process the recommendations as needed to fine-tune the analysis and resolution processes.

The action module 66 may be configured as an action triggering module, which may include pattern recognition using NLP techniques to analyze ticket comments for specific phrases or patterns. Automated actions may include detecting keywords and triggering predefined actions based on the content analysis.

The data ingestion layer 46 may be configured to connect to a ticketing system of a cloud security service (e.g., offered by a cloud service provider) via APIs. Also, the data ingestion layer 46 may be configured to retrieve ticket data, including descriptions, comments, and updates. The pre-processing engine 48 may be configured to clean and normalize text data and also remove sensitive information to comply with data privacy regulations.

The LLM 44 may be a domain-specific LLM configured to a) be fine-tuned on the domain's historical ticket data, and b) understand cloud security terminology and common issues. The embedding model (e.g., embedding module 58) and vector database 62 may be configured to a) convert ticket content into numerical vectors, and b) store vectors in a database for efficient similarity searches. The action module 66 or Action Triggering Module may be configured to a) analyze ticket comments using natural language processing, and b) detect patterns and trigger predefined actions.

An operational workflow, for example, may include:
1. Dynamic Ticket Summarization—generating an initial summary at the time of ticket creation, updating the summary as additional information becomes available, and allowing support agents (e.g., agent 43) to view a concise, current summary of the ticket at any time
2. Solution Recommendation—processing ticket content into embeddings for semantic representation, conducting similarity searches within the vector database to find relevant past tickets, and recommending solutions that have been successful in resolving similar issues.
3. Automated Action Triggering—monitoring ticket comments for specific triggers, such as diagnostic requests or escalations, and automated follow-up actions based on detected keywords or phrases.

### Computing System

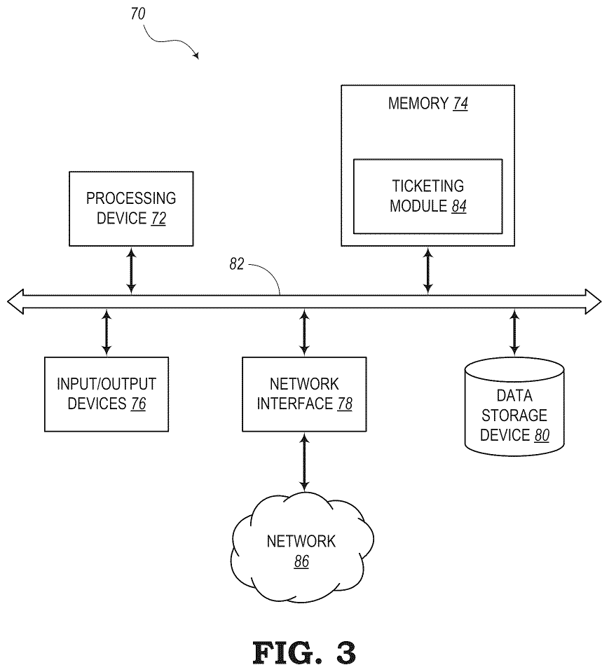

FIG. 3 is a block diagram illustrating an embodiment of a computing system 70 of a ticketing platform. As shown in its simplified form, the computing system 70 includes a processing device 72, memory 74, Input/Output (I/O) devices 76, a network interface 78, and a data storage device 80 (or database), interconnected with each other via a local interface 82 (or bus).

The processing device 72 may include one or more processors or microprocessors, such as a Central Processing Unit (CPU), which is configured to execute instructions and process data. The processing device 72 may be a general-purpose processor, a special-purpose processor, an Application-Specific Integrated Circuit (ASIC), or any combination thereof. The processing device 72 is configured to perform various computational tasks and manage the operations of the computing system 70, including executing software instructions stored in the memory 74. In some embodiments, the processing device 72 may also include or be coupled to a Graphics Processing Unit (GPU), a Digital Signal Processor (DSP), or other specialized processing units that assist in performing specific functions such as image processing, machine learning, or data analysis. The processing device 72 may operate in conjunction with other components of the computing system 70, communicating via the local interface 82.

The memory 74 in the computing system 70 may include any combination of volatile and non-volatile memory components, such as Random-Access Memory (RAM), Read-Only Memory (ROM), flash memory, and other forms of computer-readable storage media. The memory 74 is configured to store software programs, applications, and data that are executed or processed by the processing device 72. The memory 74 may also store an Operating System (O/S) and/or operating instructions that manage the overall operation of the computing system 70. In some embodiments, the memory 74 may be further subdivided into different types, such as main memory (e.g., dynamic RAM) for temporary storage of active data, and secondary memory (e.g., non-volatile memory) for storing data persistently even when the system is powered down. The memory 74 may be dynamically allocated by the computing system 70, and it may be accessible by the processing device 72 and other components via the local interface 82.

The I/O devices 76 allow the computing system 70 to interact with a user, the external environment, and other systems. Input devices may include, but are not limited to, keyboards, mice, touchscreens, microphones, and other sensors or control devices that enable the user to input commands or data into the system. Output devices may include displays, printers, speakers, or haptic feedback devices that allow the computing system 70 to convey information or feedback to the user or external systems. In some embodiments, the I/O devices 76 may also include peripheral devices such as cameras, scanners, or biometric sensors. These I/O devices 76 may be directly connected to the computing system 70 or may communicate with the computing system 70 wirelessly, such as via the network interface 78.

The network interface 78 facilitates communication between the computing system 70 and external networks, such as network 86, a local area network (LAN), a wide area network (WAN), or the Internet. The network interface 78 may include both wired and wireless communication capabilities, such as Ethernet, Wi-Fi, Bluetooth, or other protocols. The network interface 78 enables the computing system 70 to transmit and receive data, connect to remote servers, or access cloud-based services. In some embodiments, the network interface 78 may be integrated with other components of the computing system 70 or implemented as a separate hardware module, and it may support various network protocols, including Transmission Control Protocol/Internet Protocol (TCP/IP), User Datagram Protocol (UDP), and others. The network interface 78 may also provide security features such as encryption, firewalls, and authentication mechanisms to ensure secure communication.

The data storage device 80 is configured to store data persistently, which may include structured data, unstructured data, program files, system logs, and other forms of digital information. The data storage device 80 may take various forms, such as a Hard Disk Drive (HDD), Solid-State Drive (SSD), or other non-volatile memory technologies. In some embodiments, the data storage device 80 is organized as a database, storing records, tables, and indexes that facilitate the efficient retrieval, updating, and management of data. The data storage device 80 may include multiple components and may be local to the computing system 70 and/or connected via a network to external storage resources, such as cloud-based storage platforms. The processing device 72 may interact with the data storage device 80 to retrieve and store data required for executing software applications, maintaining system logs, or providing data for analytical processes.

The various hardware components of the computing system 70, including the processing device 72, memory 74, I/O devices 76, network interface 78, and data storage device 80, communicate with each other over the local interface 82. This local interface 82 may be implemented as a bus, such as a system bus, memory bus, or input/output bus, which provides a communication pathway between the different components. The bus may be based on any standard bus architecture, including but not limited to Peripheral Component Interconnect (PCI), Universal Serial Bus (USB), or Advanced Microcontroller Bus Architecture (AMBA). In some embodiments, the local interface 82 may include multiple buses or communication channels that handle different types of data traffic, such as high-speed data transfers between the memory 74 and the processing device 72, or lower-speed communication with the I/O devices 76 or peripheral devices. The local interface 82 allows for the efficient exchange of data between components and ensures synchronized operation of the system.

In addition, the computing system 70 includes a ticketing module 84, which may be implemented in any suitable combination of hardware (e.g., in the processing device 72) or software/firmware (e.g., in the memory 74). The ticketing module 84 may be stored in non-transitory computer-readable media (e.g., memory 74) and may include logic code having instructions that, when executed, enable or cause the processing device 72 to perform certain ticket management functions as described in the present disclosure.

### Example Screenshots in a Ticketing System

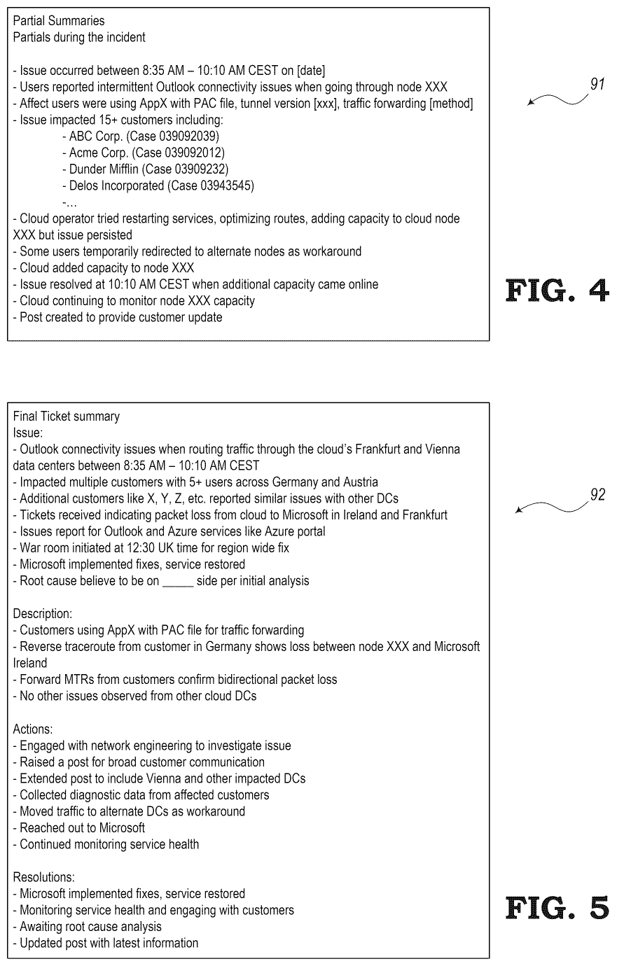

FIG. 4 is an example of a screenshot 91 showing partial summaries of a customer service ticket involving an example situation in which an outage of a software application is detected and managed. As shown in FIG. 4, a number of partial summaries (e.g., short descriptive events, conditions, responses, etc.) are shown. For example, the partial summaries may include a short description of the overall issue to be fixed, the times and dates when the issue was detected, a number of entities (e.g., people, clients, customers, devices, etc.) affected by the issue, a list of the affected entities, root cause analysis, information regarding attempts to resolve the issue, one or more actions that ultimately resolved the issue, on or more actions that partially contributed to resolving the issue, one or more actions that neither resolved the issue nor partially contributed to resolving the issue, domain equipment monitored, time and date when the issue was resolved, etc.

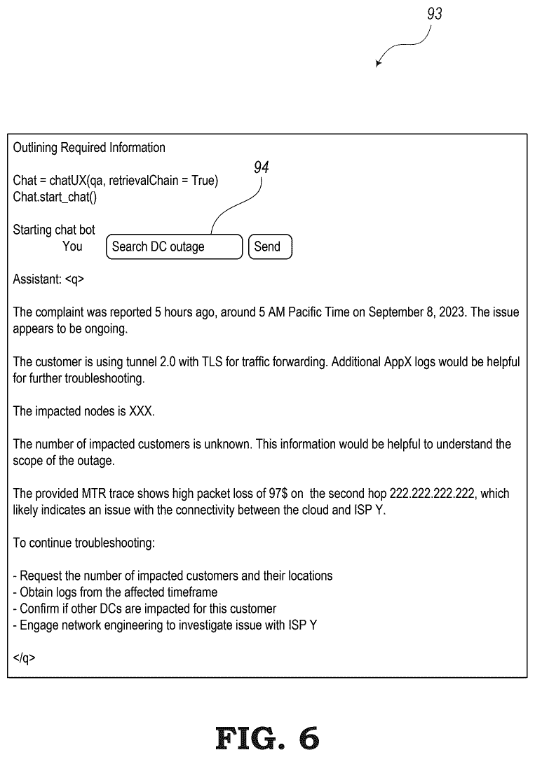

FIG. 5 is an example of a screenshot 92 showing a final ticket summary of the customer service ticket example of FIG. 4. Again, as described with respect to FIGS. 1 and 2, the ticket summary may be considered to be dynamic while a solution is being detected and while additional information or device parameters are being obtained. This may include an iterative process of requesting additional data from a domain user, automatically obtaining additional network metrics, re-processing the updated ticket information with respect to LLM processing and nearest neighbor comparisons with vectors in a vector database, etc.

For example, the final ticket summary shown in FIG. 5 may include a list of a) issues, b) descriptions, c) actions, and d) resolutions. The “issues” in this case may include a brief description of the overall issue, when the issue occurred, where the issue occurred, data centers and domains affected, customer impacted by the issue, reporting information, fixes attempted, root cause analysis, etc. The “description” in this case may include traffic and trace route characteristics obtained. The “actions” in this case may include personnel involvement, raising or extending a trust post, collecting diagnostic data from affected customers, rerouting traffic, contacting software developers or hardware manufacturers, continuing monitoring services, and the like, whereby a “trust post” may refer to an incident resolution status or an issue with an enrollment service. For example, a trust post for the enrollment service might be for issues with new users or re-logins. Also, the “resolutions” in this case may include information regarding fixes, service restorations, service health monitoring, engaging with customers, awaiting third party root cause analysis, updating a trust post, etc.

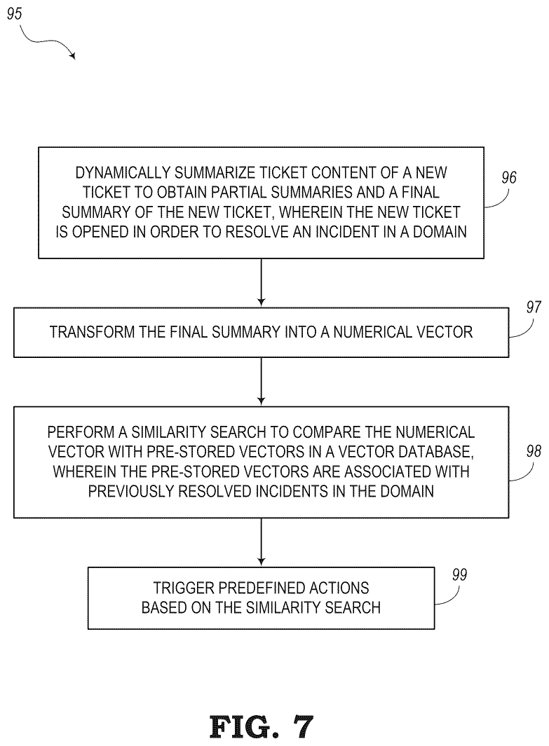

FIG. 6 is an example of a screenshot 93 showing an entry field 94 and a summary in a chatbot. In this example, the user may be able to copy and paste a long entry of a summary and description (with respect to a ticket) in the entry field 94. The LLM or chatbot may be configured to handle the ticket information using the processes described herein to provide summaries and additional instructions as needed to resolve a domain-based issue.

### Ticket Handling Method

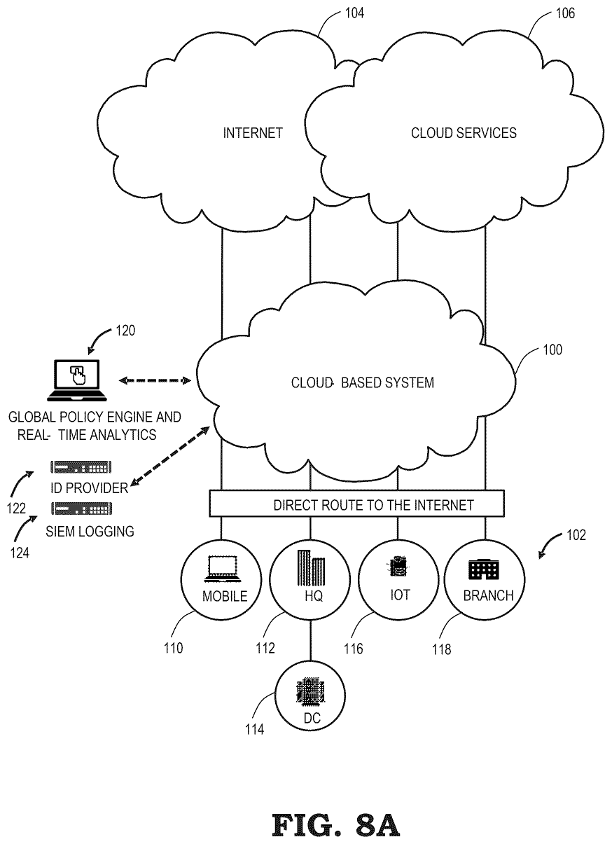

FIG. 7 is a flow diagram illustrating an embodiment of a method 95 for utilizing LLMs for processing a customer service ticket. As shown, the method 95 includes a step of dynamically summarizing ticket content of a new ticket to obtain partial summaries and a final summary of the new ticket, as indicated in block 96. For instance, the new ticket is opened in order to resolve an incident in a domain. The method 95 further includes a step of transforming the final summary into a numerical vector, as indicated in block 97. Also, the method 95 includes a step of performing a similarity search to compare the numerical vector with pre-stored vectors in a vector database, as indicated in block 98. The pre-stored vectors, for example, are associated with previously resolved incidents in the domain. The method 95 also includes a step of triggering predefined actions based on the similarity search, as indicated in block 99.

According to some embodiments, the method 95 may further include a step of employing an LLM trained with previous cloud security tickets and cloud security knowledge. The new ticket, for example, may be related to cybersecurity alerts, issues, and monitored network data within a cloud-based cybersecurity environment. The method 95 may further include steps of a) retrieving ticket descriptions, comments, and updates, and b) cleaning and normalizing ticket data and removing sensitive information for privacy compliance.

In some embodiments, the method 95 may also include utilizing a RAG module to assist with retrieving similar tickets from the vector database. The ticket content, in some embodiments, may include user queries, user questions, initial input, requests, issues, alerts, concerns, new ticket information, descriptions, and/or comments regarding one or more issued detected within a domain. The predefined actions, in some embodiments, may include one or more resolution procedures for resolving or attempting to resolve an incident detected within a domain.

In addition, the method 95 may also include requesting additional data with respect to the domain for updating the partial summaries. The step of triggering predefined actions may include a step of recommending solutions based on the previously resolved incidents. The new ticket, for example, may be related to customer service, customer support, IT support, HR support, project management, workflow management, task management, workflow coordination, application assistance, software development, software bug and issue tracking, solution recommendation, and/or issue resolution.

### Cloud-Based System Architecture

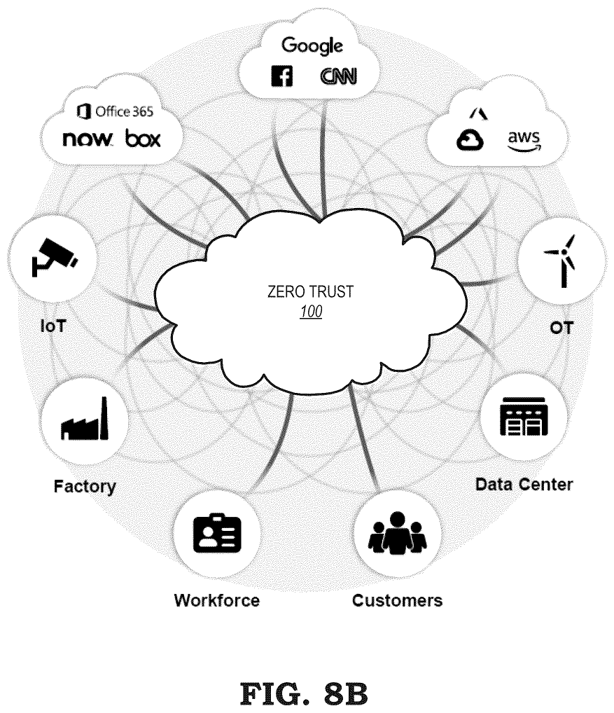

FIG. 8A is a network diagram of a cloud-based system 100 (e.g., cloud-based security system, Zero Trust System, etc.) offering security as a service. Specifically, the cloud-based system 100 can offer a Secure Internet and Web Gateway as a service to various users 102, as well as other cloud services. In this manner, the cloud-based system 100 is located between the users 102 and the Internet 104 as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via a Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications, such as those related to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

For illustration purposes, the users 102 of the cloud-based system 100 can include devices 110 (e.g., mobile devices, end user devices, agent devices, etc.), locations 112 (e.g., a headquarters (HQ), office, etc.) which can include or connect to a data center (DC) 114, Internet of Things (IOT) devices 116, a branch office/remote location 118, etc., and each includes one or more user devices. The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters (e.g., locations 112) can include an enterprise's network with resources in the data center 114. The devices 110 can be a so-called road warrior devices, i.e., for users that are off-site, on-the-road, etc. Those skilled in the art will recognize a user 102 has to use a corresponding user device for accessing the cloud-based system 100 and the like, and the description herein may use the user 102 and/or the user device interchangeably.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes—they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 116) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. An application of the local application is the application 350 described in detail herein as a connector application. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

### Zero Trust

FIG. 8B is a logical diagram of the cloud-based system 100 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud-based system 100. Zero trust is a cybersecurity strategy wherein security policy is applied based on context established through least-privileged access controls and strict user authentication—not assumed trust. A well-tuned zero trust architecture leads to simpler network infrastructure, a better user experience, and improved cyberthreat defense.

Establishing a zero trust architecture requires visibility and control over the environment's users and traffic, including that which is encrypted; monitoring and verification of traffic between parts of the environment; and strong multifactor authentication (MFA) methods beyond passwords, such as biometrics or one-time codes. This is performed via the cloud-based system 100. Critically, in a zero trust architecture, a resource's network location is not the biggest factor in its security posture anymore. Instead of rigid network segmentation, your data, workflows, services, and such are protected by software-defined microsegmentation, enabling you to keep them secure anywhere, whether in your data center or in distributed hybrid and multicloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

FIG. 8C is a logical diagram illustrating zero trust policies with the cloud-based system 100 and a comparison with the conventional firewall-based approach. Zero trust with the cloud-based system 100 allows per session policy decisions and enforcement regardless of the user 102 location. Unlike the conventional firewall-based approach, this eliminates attack surfaces, there are no inbound connections; prevents lateral movement, the user is not on the network; prevents compromise, allowing encrypted inspection; and prevents data loss with inline inspection.

### Example Implementation of the Cloud-Based System

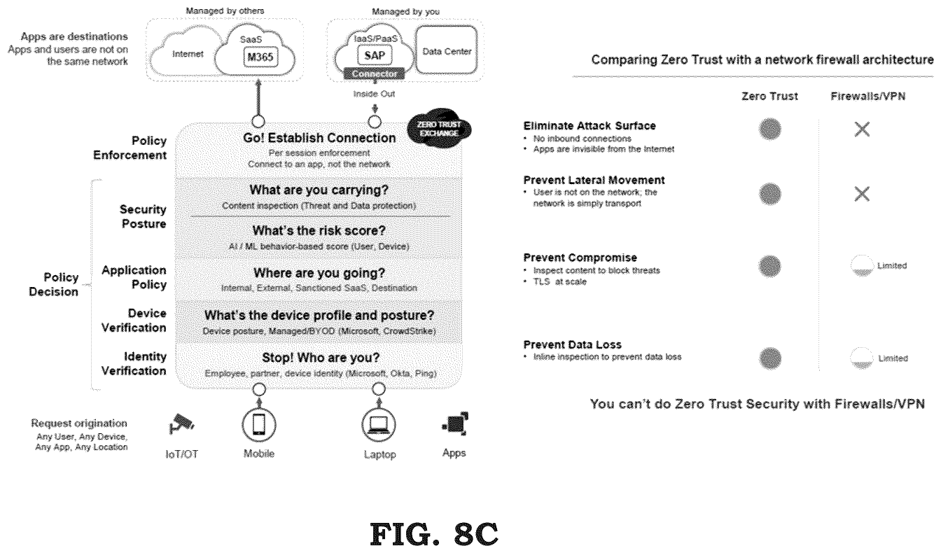

FIG. 9 is a network diagram of an example implementation of the cloud-based system 100. In an embodiment, the cloud-based system 100 includes a plurality of enforcement nodes (ENs) 150, labeled as enforcement nodes 150-1, 150-2, . . . , 150-N, interconnected to one another and interconnected to a central authority (CA) 152. The enforcement nodes 150 and the central authority 152, while described as nodes, can include one or more servers, including physical servers, virtual machines (VM) executed on physical hardware, etc. The cloud-based system 100 further includes a log router 154 that connects to a storage cluster 156 for supporting log maintenance from the enforcement nodes 150. The central authority 152 provides centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150.

Of note, the cloud-based system 100 is an external system meaning it is separate from tenant's private networks (enterprise networks) as well as from networks associated with the devices 110, 116, and locations 112, 118. Also, of note, the present disclosure describes a private enforcement node 150P that is both part of the cloud-based system 100 and part of a private network. Further, of note, the enforcement node described herein may simply be referred to as a node or cloud node. Also, the terminology enforcement node 150 is used in the context of the cloud-based system 100 providing cloud-based security. In the context of secure, private application access, the enforcement node 150 can also be referred to as a service edge or service edge node. Also, a service edge node of the enforcement nodes 150 can be a public service edge node (part of the cloud-based system 100) separate from an enterprise network or a private service edge node (still part of the cloud-based system 100) but hosted either within an enterprise network, in a data center 114, in a branch office/remote location 118, etc. Further, the term nodes as used herein with respect to the cloud-based system 100 (including enforcement nodes, service edge nodes, etc.) can be one or more servers, including physical servers, virtual machines (VM) executed on physical hardware, etc., as described above. The service edge node of the enforcement nodes 150 can also be a Secure Access Service Edge (SASE).

The enforcement nodes 150 are full-featured secure internet gateways that provide integrated internet security. They inspect all web traffic bi-directionally for malware and enforce security, compliance, and firewall policies, as described herein, as well as various additional functionality. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure Transport Layer Security (TLS) connections to the log routers 154 that direct the logs to the storage cluster 156, hosted in the appropriate geographical region, for each organization. In an embodiment, all data destined for or received from the Internet is processed through one of the enforcement nodes 150. In another embodiment, specific data specified by each tenant, e.g., only email, only executable files, etc., is processed through one of the enforcement nodes 150.

Each of the enforcement nodes 150 may generate a decision vector D=[d1, d2, . . . , dn] for a content item of one or more parts C=[c1, c2, . . . , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the enforcement node 150 may allow the distribution of the content item, preclude distribution of the content item, allow distribution of the content item after a cleaning process, or perform threat detection on the content item. In an embodiment, the actions taken by one of the enforcement nodes 150 may be determinative on the threat classification of the content item and on a security policy of the tenant to which the content item is being sent from or from which the content item is being requested by. A content item is violating if, for any part C=[c1, c2, . . . , cm] of the content item, at any of the enforcement nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

The policy can be tenant-specific and can include access privileges for users, websites and/or content that is disallowed, restricted domains, DLP dictionaries, etc. Once downloaded, a tenant's policy is cached until a policy change is made in the management system 120. The policy can be tenant-specific and can include access privileges for users, websites and/or content that is disallowed, restricted domains, DLP dictionaries, etc. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud services 106 are any services made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), Zscaler Posture Control (ZPC), and Zscaler Digital Experience (ZDX), all from Zscaler, Inc. (the assignee and applicant of the present application). Also, there can be multiple different cloud-based systems 100, including ones with different architectures and multiple cloud services. The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). ZPC is a Cloud-Native Application Protection Platform (CNAPP) which is a new category of security products, encompassing the functionality previously found in Cloud Security Posture Management (CSPM) and Cloud Workload Protection Platform (CWPP) products and more. Those of ordinary skill in the art will recognize various other types of cloud services 106 are also contemplated. Also, other types of cloud architectures are also contemplated, with the cloud-based system 100 presented for illustration purposes.

### Digital Experience Monitoring (DEM)

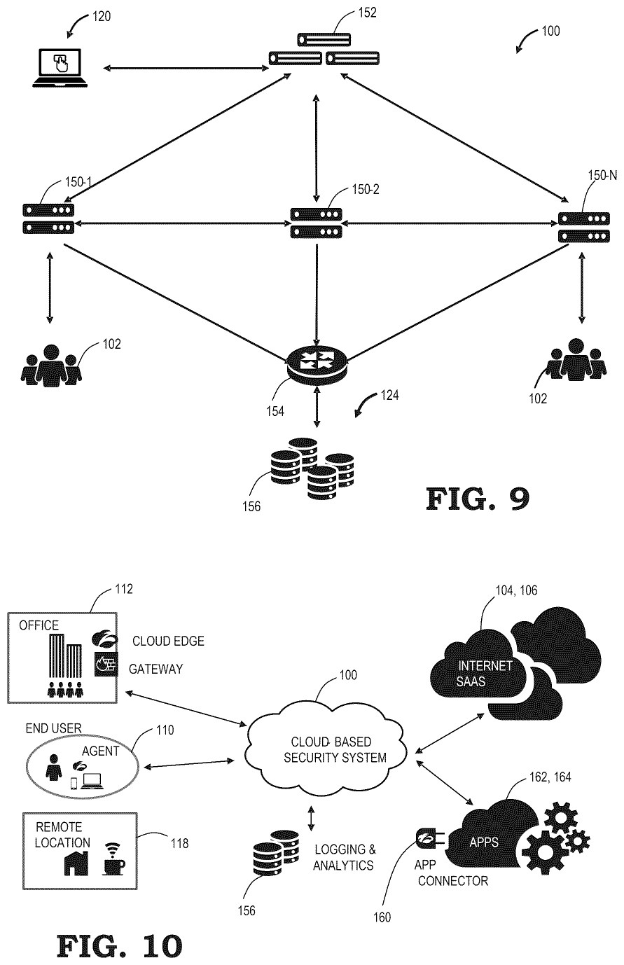

FIG. 10 is a network diagram of the cloud-based system 100 in an application of digital experience monitoring. Here, the cloud-based system 100 providing security as a service as well as ZTNA, can also be used to provide real-time, continuous digital experience monitoring, as opposed to conventional approaches (synthetic probes). A key aspect of the architecture of the cloud-based system 100 is the inline monitoring. This means data is accessible in real-time for individual users from end-to-end. As described herein, digital experience monitoring can include monitoring, analyzing, and improving the digital user experience.

The cloud-based system 100 connects users 102 at the locations 112, 118 to the applications 162, 164, the Internet 104, the cloud services 106, etc. The inline, end-to-end visibility of all users enables digital experience monitoring. The cloud-based system 100 can monitor, diagnose, generate alerts, and perform remedial actions with respect to network endpoints, network components, network links, etc. The network endpoints can include servers, virtual machines, containers, storage systems, or anything with an IP address, including the Internet of Things (IoT), cloud, and wireless endpoints. With these components, these network endpoints can be monitored directly in combination with a network perspective. Thus, the cloud-based system 100 provides a unique architecture that can enable digital experience monitoring, network application monitoring, infrastructure component interactions, etc. Of note, these various monitoring aspects require no additional components—the cloud-based system 100 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud-based system 100 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud-based system 100 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud-based system 100 can operate at 10 gigabits (10G) Ethernet and higher at full line rate and support a rate of 100,000 or more flows per second or higher.

The applications 162, 164 can include enterprise applications, Office 365, Salesforce, Skype, Google apps, internal applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 350 or the cloud edge to quantify user experience for specific applications, i.e., the application-related and device-related data. The cloud-based system 100 can further collect the network-related and the protocol-related data (e.g., Domain Name System (DNS) response time).

### Application-Related Data

| | |
|---|---|
| Page Load Time | Redirect count (#) |
| Page Response Time | Throughput (bps) |
| Document Object Model (DOM) Load | Total size (bytes) |
| Time | |
| Total Downloaded bytes | Page error count (#) |
| App availability (%) | Page element count |
| | by category (#) |

### Network-Related Data

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

### Device-Related Data (Endpoint-Related Data)

| System details | Network (config) |
|---|---|
| Central Processing Unit (CPU) | Disk |
| Memory (RAM) | Processes |
| Network (interfaces) | Applications |

Metrics could be combined. For example, device health can be based on a combination of CPU, memory, etc. Network health could be a combination of Wi-Fi/LAN connection health, latency, etc. Application health could be a combination of response time, page loads, etc. The cloud-based system 100 can generate service health as a combination of CPU, memory, and the load time of the service while processing a user's request. The network health could be based on the number of network path(s), latency, packet loss, etc.

The lightweight connector 160 can also generate similar metrics for the applications 162, 164. In an embodiment, the metrics can be collected while a user is accessing specific applications that user experience is desired for monitoring. In another embodiment, the metrics can be enriched by triggering synthetic measurements in the context of an inline transaction by the application 350 or cloud edge. The metrics can be tagged with metadata (user, time, app, etc.) and sent to a logging and analytics service for aggregation, analysis, and reporting. Further, network administrators can get UEX reports from the cloud-based system 100. Due to the inline nature and the fact the cloud-based system 100 is an overlay (in-between users and services/applications), the cloud-based system 100 enables the ability to capture user experience metric data continuously and to log such data historically. As such, a network administrator can have a long-term detailed view of the network and associated user experience.

### User Experience Ticketing System

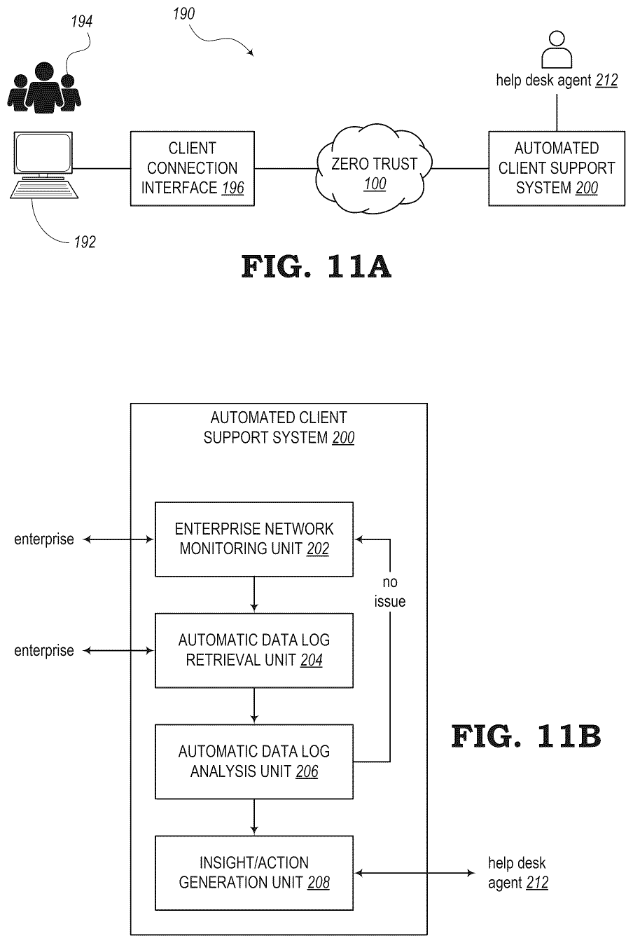

FIG. 11A is diagram illustrating an embodiment of a User Experience (UX) ticketing system 190, which may be configured for performing Digital Experience Monitoring (DEM) procedures, such as those described with respect to FIG. 10. As shown, the UX ticketing system 190 includes a number of end user devices 192 of an enterprise network or organizational domain. The end user devices 192 may include computers, laptops, tablets, mobile phones, etc. used by a number of end users 194 or clients. Furthermore, the UX ticketing system 190 includes a client connection interface 196 (e.g., Zscaler Client Connector (ZCC), etc.), which may be configured to provide a layer of security between the enterprise and the Internet. The UX ticketing system 190 may also include a Zero Trust network or cloud-based system 100. In addition, the UX ticketing system 190 includes an automated client support system 200 (e.g., help desk system, user experience system, ticket system, etc.). The automated client support system 200 may be used by one or more help desk agents 212. In some embodiments, many of the typical help desk services can be automated to simplify the support services provided to the client. Also, recommendations and insights of the enterprise can be communicated to the help desk agents 212 to include a human element in actions that are taken on behalf of the enterprise to improve the user experience.

In particular, the UX ticketing system 190 may be configured as an intelligent automatic data log collection system that automatically retrieves data logs based on the existence of specific triggers within the end user devices 192 of the enterprise. The gathered data logs can then be analyzed to determine any adverse conditions of the end user devices 192 or other equipment of the enterprise and then present insights or suggested actions to the help desk agent 21 to remediate issues in the enterprise that might cause a decline in the user experience. In other words, any faults, deterioration events, or other adverse conditions may cause problems that would normally create a situation where the user experience would not be optimized (e.g., lag, latency, error codes, loss of signal, loss of connection, etc.).

According to conventional systems, the end users 194 may experience issues in the enterprise and may then create a ticket in an IT ticket management system (e.g., SalesForce, ServiceNow, Zen Desk, etc.). In the conventional system, the service desk engineer might use a UX app for monitoring the users' digital experience. The engineer may need to sift through various dashboards and device events, piecing together what occurred at the time of the reported issue. Following this initial investigation, the engineer may then request specific logs from the user, which the user would then collect and send back to the engineer. At this point, the engineer may then analyze these logs to determine the appropriate action. However, it should be noted that the conventional methodology is highly manual, which may lead to increased Mean Time to Detect (MTTD) and Mean Time to Resolve (MTTR) issues. For example, MTTD refers to the average amount of time it takes for a system or team to identify and discover a security incident or problem, essentially measuring how long it takes to detect an issue from the moment it occurs until it is noticed by the monitoring system or team. Also, MTTR refers to the average time it takes to fix a problem from the time it is detected to the time it is resolved.

The UX ticketing system 190 and other systems and methods of the present disclosure are configured to overcome many of the issues of the conventional systems. For example, the UX ticketing system 190 is configured to automate the log collecting and log analysis steps, when possible. The UX ticketing system 190 implements a ticketing process by intelligently triggering log collection based on user experience deterioration or other predefined triggers. The UX ticketing system 190, which may be implemented as a cloud-based service, may be configured to automatically retrieve data logs, where automated log analysis would generate insights and suggest actions to mitigate the issues. This approach is configured to significantly reduce MTTD and MTTR.

### Automated Client Support System

FIG. 11B is a block diagram illustrating an embodiment of the automated client support system 200 shown in FIG. 11A. In this embodiment, the automated client support system 200 (or help desk app) includes an enterprise network monitoring unit 202, an automatic data log retrieval unit 204, an automatic data log analysis unit 206, and an insight/action generation unit 208. The enterprise network monitoring unit 202 is configured to monitor the end user device 192 of the enterprise network. In response to detecting one or more adverse conditions of the enterprise network that imply a decline in one or more UX metrics, the enterprise network monitoring unit 202 may be configured to send a signal to the automatic data log retrieval unit 204 to instruct it to automatically collect data logs from the enterprise network. Next, the automatic data log analysis unit 206 is configured to automatically analyze the data logs gathered by the automatic data log retrieval unit 204. If the automatic data log analysis unit 206 does not detect any issues, then a signal can be sent to the enterprise network monitoring unit 202 to continue with generating monitoring actions. However, in response to the automatic data log analysis unit 206 determining that the data logs indicate one or more issues in the enterprise network, then the analysis information is sent to the insight/action generation unit 208, which is configured to suggest actions to the help desk agents 212 to remediate the one or more issues or adverse conditions. By correcting these issues in the enterprise, the UX would naturally improve. It may be noted that, in some embodiments, the automated client support system 200 may be implemented in software, firmware, or computer code (e.g., part of the ticketing module 84) and stored in a computer-readable medium or the memory 74.

### Automated Help Desk Method for Remediating User Experience Issues

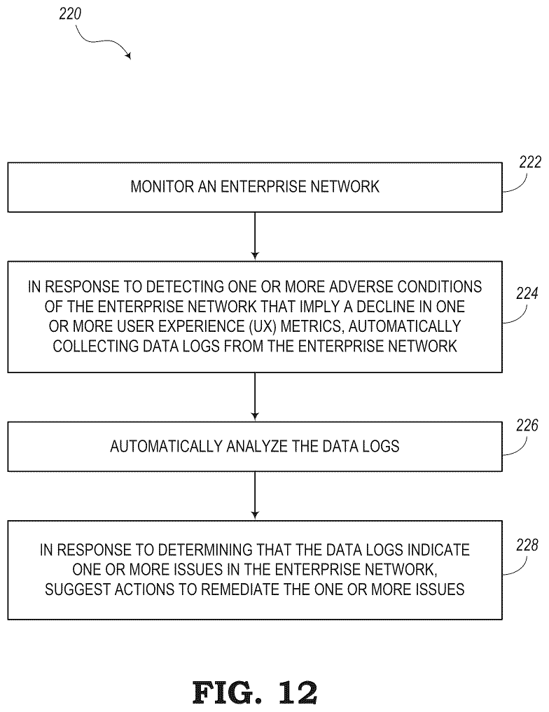

FIG. 12 is a flow diagram illustrating an embodiment of a method 220 for implementing an automated help desk in order to remediate UX issues or other adverse conditions in an enterprise network. As shown in FIG. 12, the method 220 includes a step of monitoring an enterprise network, as indicated in block 222. In response to detecting one or more adverse conditions of the enterprise network that imply a decline in one or more User Experience (UX) metrics, the method 220 includes a step of automatically collecting data logs from the enterprise network, as indicated in block 224. Next, the method 220 includes a step of automatically analyzing the data logs, as indicated in block 226. In response to determining that the data logs indicate one or more issues in the enterprise network, the method 220 includes a step of suggesting actions to remediate the one or more issues, as indicated in block 228.

According to some embodiments, the method 220 may further include a step of generating one or more insights or recommendations for consideration by a help desk agent. The step of automatically collecting data logs (block 224), for example, may be automatically triggered by a detected decline in the one or more UX metrics or specific adverse conditions in the enterprise network. In some embodiments, an action of searching for one or more adverse conditions of the enterprise network may include a step of monitoring device events of one or more end user devices incorporated in the enterprise network.

The method 220, in some implementations, may also include a step of preemptively collecting data logs before opening a service ticket. The method 220 may also include a step of determining whether the one or more adverse conditions of the enterprise network are a root cause of the decline in the one or more UX metrics. The one or more adverse conditions, for example, may include a) a drop in application performance with respect to one or more end user devices associated with the enterprise network, b) recurring connectivity issues with respect to the one or more end user devices, and/or c) a deviation of the one or more end user devices from normal device behavior. In some embodiments, each data log may have a depth that corresponds to a severity of an adverse condition of the enterprise network.

### Additional Considerations

Some of the benefits of the systems and methods of the present disclosure may include increased productivity and efficiency. For example, by employing the automated client support system 200 and/or executing the method 220 for implementing an automated help desk in order to remediate UX issues or other adverse conditions in an enterprise network, the service desk engineers can focus on resolving issues rather than manually collecting and analyzing logs manually.

Also, the present disclosure promotes reduced support costs, whereby automation is able to reduce the need for extensive manual labor. This may translated to less manual work, such that log collection and analysis can be streamlined and automated. In addition, another benefit is that the systems and methods described herein are able to provide faster turnaround time. That is, the embodiments disclosed herein are able to provide quicker issue resolution to enhance user satisfaction.

It may be noted that the systems and methods include various novel aspects as compared to traditional systems. For example, the present embodiments are configured with integrated automation, whereby the processes integrate device event monitoring, log collection, and log analysis into a seamless, automated workflow. Also, the embodiments have bundled capabilities, where, unlike competitor observability products, the solutions offered by the present disclosure are configured to combine all necessary capabilities into one package, while conventional solutions normally require external log monitoring platforms (e.g., Splunk, Datadog, etc.).

The systems and methods of the present disclosure are configured to provide intelligent triggering, whereby log collection is automatically triggered based on device events, user experience deterioration, and other critical factors. Also, the present systems and methods include advanced log analysis, whereby the systems are configured to employ various techniques for log analysis and for providing actionable insights and recommendations.

The following is an example scenario in which the embodiments described herein may be utilized. Suppose a user is experiencing consistent connectivity issues. In a conventional situation, the user will go and log a ticket with their IT support team. Then, the service desk engineer will use a help desk platform and various other tools to determine the root cause of the connection issue. If these tools cannot easily find the root cause, then they will request client logs from the user (client) and analyze the logs for potential network or application issues. Again, this can be a more lengthy and tedious manual process. However, the systems and methods of the present disclosure are configured improve upon the conventional systems by proposing an intelligent automated version, which is configured to take a look at the device connectivity related events that are received (e.g., using Zscaler ZDX), such as “zcc_zia_network_error” or “zcc_zia_auth_error,” along with other factors and heuristically decide to trigger log collection and automated log analysis and then finally apply a fix, such as restarting a client connection service (e.g., ZCC).

Certain events or conditions in an enterprise network may be viewed as “triggers” for triggering the automated collection of data logs. For example, triggers could include sudden drops in application performance, recurring connectivity issues, or significant deviations from normal device behavior. Any number of end user devices 192 (e.g., specific end users 194, specific groups, specific departments, etc.) may be targeted in the enterprise network for analysis and log collection.

In particular, data logs may include any number of parameters and may have any suitable length, depending on the type of parameters being obtained. In some cases, the length (verbosity) of the logs collected can be adjusted based on the severity of the issue. For instance, the logs may range from basic logs for minor issues to detailed logs for more serious problems.

Also, the log management systems may be extended to various metrics and “middle boxes” (e.g., client connection interface 196). Beyond logs, the UX ticketing system 190 could also collect relevant metrics and data from the client connection interface 196 (e.g., intermediary network devices, middle boxes, etc.). For instance, if multiple laptops exhibit issues, the UX ticketing system 190 could trigger log collection from relevant network routers or switches to identify potential network-wide problems. Thus, this intelligent, automated approach to log collection and analysis represents a significant advancement in IT support, driving efficiency and improving user satisfaction.

Some of the systems and methods of the present disclosure may be referred to as “automated user experience help desk systems” and may include any suitable software platform that leverages technology (e.g., AI models, ML models, LLMs, etc.) to streamline the process of resolving user support issues by automating repetitive tasks like ticket routing, initial troubleshooting, and providing self-service options, thereby improving the overall user experience by offering faster response times and reducing the need for manual agent intervention.

In some embodiments, the automated user experience help desk systems may include a) a self-service portal, where a knowledge base with readily accessible articles, FAQs, and tutorials allow users to find answers to common issues independently, b) chatbots, such as AI-powered conversational agents that can answer basic questions, guide users through troubleshooting steps, etc., c) ticket automation, which can automatically assign tickets to the appropriate support agent based on issue type, priority, and user information, d) smart routing, such as dynamically routing tickets based on complex rules and user context, ensuring issues reach the most qualified agent, e) automated status updates, where a system can automatically notify users about ticket progress and resolution updates, and f) issue escalation, which can escalate tickets to higher-level support teams when necessary, without manual intervention.

Again, some of the benefits of an automated user experience help desk system may include:
1. Faster response times: By automating routine tasks, agents can focus on more complex issues, leading to quicker resolutions.
2. Improved user satisfaction: Self-service options and quicker resolution times enhance the user experience.
3. Reduced agent workload: Automating repetitive tasks frees up agents to handle more complex issues.
4. Increased efficiency: Streamlined workflows and automated processes improve overall help desk operations.

The systems and methods described herein may provide certain other advantages over conventional systems. For example, the embodiments disclosed herein may increase efficiency and may reduce the time needed to resolve each ticket by providing immediate access to relevant historical information. The embodiments may also provide consistency in the system, whereby the present ticketing systems are configured to standardize the handling of similar issues, reducing reliance on individual agents. Also, the present embodiments are able to retain knowledge of prior solutions in an ongoing continuous manner, such as by capturing organizational knowledge from historical cases, facilitating long-term knowledge management, etc. Another advantage is that the present systems are configured to enhance the customer experience by providing accelerated resolution times, promoting proactive responses, and building customer trust.

Thus, benefits of the embodiments of the present disclosure may include:
A. Increased Efficiency:
   1. Reduces time spent on each ticket.
   2. Provides immediate access to relevant information.
B. Consistency:
   1. Ensures uniform handling of similar issues.
   2. Reduces reliance on individual agent experience.
C. Knowledge Retention:
   1. Leverages historical data effectively.
   2. Captures organizational knowledge for future use.
D. Improved Customer Satisfaction:
   1. Faster resolutions enhance the customer experience.
   2. Proactive responses build customer trust.

The systems and methods are configured to handle any number of customer domains, based on pre-stored historical resolution plans and knowledge of each domain or customer. The feature of being domain specific may include training with supervisory or historical ticket data and relying on a knowledge base defining each specific type of domain. The knowledge base may include domain-specific terminology, knowledge, keywords, common issues, etc. with respect to each type of domain. Private data regarding cloud-based security environments may include an understanding of cloud security terminology and services, including precise context-aware automation to improve efficiency. For example, the domain may be a cybersecurity system, domain, environment, platform, etc.

The data ingestion layer may be configured to receive ticket data, comments, and updates. The pre-processing engine may include APIs between user input and ticketing engine (or customer support system) with the LLM. The pre-processing engine may be configured to clean and normalize data and remove sensitive data to comply with privacy regulations. The embedding module and vector database may convert ticket data from multiple historical tickets with solutions to numerical vectors and store these vectors in the vector database and enable searching with new vector of new ticket data for similarity with stored vectors to get recommended solutions. The action triggering module may be based on NLP of pre-determined ticket data and patterns thereof, as compared in the similarity search, and can get solutions from the similar tickets fetched from the vector DB and automatically perform or recommend a suitable solution.

The summarization units may be configured dynamically creating and modifying partial summaries and final summaries. Also, the systems and methods may be configured to combine tickets related to the same or similar issues to reduce ticket fatigue. Issues or incidents to be resolved may include network congestion, data center routing, service downtime, authentication problem, access failure, problems with security configuration and policy settings. Advantages of the present embodiments may further include reducing time on each ticket, providing immediate feedback to relevant information, ensuring uniform handling of similar issues, reducing reliance on human bias, and ongoing training to improve results.

In some embodiments, the LLM may be configured to automatically generate a summary of each support ticket upon ticket creation and continuously update the summary with new ticket information. The embedding model, for example, may be configured to process ticket content into vector representations for semantic comparison with historical ticket data, enabling solution recommendations based on similarity searches. The action triggering module, for example, may be configured to detect predefined keywords or patterns in ticket comments and initiate automated actions, including requesting additional diagnostics, suggesting relevant support tools, or escalating the ticket.

A process for enhancing customer support in a cloud-based security platform may include steps of a) retrieving ticket data, including descriptions, comments, and updates, from a ticketing system, b) processing and cleaning the retrieved data to remove sensitive information, c) generating an initial summary of each ticket upon ticket creation and updating the summary as new information is added, d) transforming ticket content into vector representations and conducting similarity searches within a historical database to recommend solutions, and e) analyzing ticket comments for specific keywords or patterns and triggering automated support actions based on detected patterns.

Furthermore, in some embodiments, the process may also be characterized in that the similarity search is configured to identify and recommend historical solutions based on embedding-based semantic analysis of ticket content. The automated support actions may include triggering requests for additional information, tool recommendations, or ticket escalation in response to predefined triggers in ticket comments.

Customer support teams, such as those for cloud-based security companies, may be configured to handle numerous tickets daily, many involving recurring issues such as:
1) Network Congestion: Problems with data center paths affecting performance.
2) VIP Downtime: Downtime impacting service availability.
3) Authentication Challenges: User authentication failures or access denials.
4) Policy Misconfigurations: Errors from incorrect security policy settings. Currently, resolving these issues may include a) multiple interactions with customers to gather information, b) manual searches through past tickets, and c) dependence on individual agent experience. However, since this manual process is time-consuming and can delay issue resolution, the systems and methods of the present disclosure are configured to overcome the shortcomings of the conventional systems and provide efficient and fast ticketing processes.

The embodiments of the present disclosure are configured to revolutionize customer support workflows within certain environments, such as a cloud-based security platform, by leveraging LLMs. The embodiments enhance customer support by integrating LLMs and embedding techniques. The systems and methods of the present disclosure are configured to

### A. Automatically and Dynamically Summarizing Ticket Progress

1. Automatic Generation: Creates concise summaries upon ticket creation.
2. Real-Time Updates: Continuously updates summaries as new information arrives.
3. Key Details Included: Issue descriptions, actions taken, findings, and next steps.

These may include a) Initial Summary—Generated upon ticket creation, b) Updates—Summaries are refreshed as new data is added, and c) Access—Agents view summaries for a quick ticket overview.

### B. Recommending Solutions Based on Historical Data

1. Semantic Analysis: Uses embedding models to represent ticket content.
2. Similarity Search: Compares current tickets to past ones stored in a vector database.
3. Recommendation Generation: Suggests proven solutions from similar historical cases.

These may include a) Vector Representation—Processes ticket content into embeddings, b) Similarity Search—Finds similar past tickets, and c) Recommendation—Suggests solutions based on historical resolutions.

### C. Automatically Triggering Actions Based on Ticket Content and Comment Analysis

1. Real-Time Monitoring: Analyzes ticket comments for specific keywords or patterns.
2. Predefined Actions: Automatically triggers actions like requesting diagnostics, suggesting tools (e.g., ZDX), or escalating tickets.
3. Proactive Response: Ensures timely and appropriate actions are taken without manual intervention.

These may include a) Monitoring—Watches for specific phrases or patterns, and b) Actions—Triggers requests for more information, tool suggestions, or escalations.

By addressing these three areas, the systems and methods of the present disclosure are configured to enhance efficiency, reduce resolution times, and improve overall customer satisfaction. The present systems may be specifically tailored to understand cloud security terminology (and Zscaler's services), providing precise, context-aware automation that significantly improves support efficiency.

In some embodiments, a ticketing system may include an automated system for dynamic summarization of customer support tickets, utilizing a domain-specific Large Language Model to generate and update summaries in real-time. A method may include recommending solutions to support tickets by semantically comparing current ticket content to historical tickets using embedding models and vector databases. Also, a system may include automated action triggering based on real-time comment analysis, detecting specific patterns or keywords and performing predefined actions accordingly.

### EXAMPLES

Below are illustrative examples of specific triggers that can automatically initiate log collection in an enterprise network, along with potential remediation techniques that a help desk system (or automated client support system) can apply after analyzing those logs. These examples reflect how user experience metrics and system health indicators can serve as real-time triggers for deeper investigation, followed by automated or guided remediation:

### 1. Application Performance Degradation

Trigger: A user's device or monitoring tool detects that a critical application (e.g., collaboration software, CRM platform) experiences a significant drop in performance (e.g., response time exceeds a defined threshold of 2 seconds for over 60 seconds).

Automated Log Collection: The system immediately gathers application logs, system event logs from the impacted devices, and relevant network logs (e.g., packet trace around the time of degradation).

Remediation Techniques:
Restart Services: Attempt an automated restart of background services or local agents connected to the app.
Resource Optimization: Suggest closing unnecessary applications or processes consuming excessive CPU or memory.
Auto-Scaling or Rerouting (in cloud contexts): If the app is hosted in a scalable infrastructure, automatically reroute user traffic to a healthier node or spin up additional compute resources.

### 2. Repeated Connectivity Failures

Trigger: Multiple connection drops or “network_error” events detected for the same user or group of users within a short time frame (e.g., three drops within 15 minutes).

Automated Log Collection: The system pulls log entries from the user's endpoint (e.g., Wi-Fi driver logs, VPN or client-connector logs) and captures relevant network diagnostic logs (e.g., DNS resolution attempts, IP gateway logs).

Remediation Techniques:
Driver/Client Update: Prompt the user or automatically install updated drivers or software connectors if an outdated version is identified as a root cause.
Network Path Rerouting: Dynamically reroute traffic via an alternative gateway or route if the primary path is experiencing high latency or packet loss.
Automated Reconnection Script: Execute a script that resets the network interface, flushes DNS, and re-establishes the connection.

### 3. High CPU or Memory Utilization on Endpoints

Trigger: A user's device consistently reports CPU utilization above 90% or memory usage above 80% for a specified time (e.g., over 5 minutes), degrading user experience.

Automated Log Collection: The system collects real-time process snapshots, system logs, and any relevant application logs that might be causing the spike (e.g., antivirus scans, runaway processes).

Remediation Techniques:
Process Termination or Restart: Automatically terminate or restart runaway processes to free up resources.
Policy Adjustment: Adjust security scan schedules or intensities if a corporate antivirus or DLP scan is overloading the system.
User Notification: Alert the user with suggestions to close resource-heavy applications or plug into a power source if on battery to mitigate thermal throttling.

### 4. Authentication Errors or Login Failures

Trigger: The system detects multiple failed login attempts or recurring “auth_error” events for a particular user or group over a short interval (e.g., more than five failures in 30 minutes).

Automated Log Collection: The system captures authentication logs (e.g., SSO logs, identity provider logs), local connector logs, and relevant security event logs to identify the source of failures.

Remediation Techniques:
Password Reset Workflow: Prompt an automatic password reset or Multi-Factor Authentication (MFA) re-verification for the user.
Account Lockout: Temporarily lock the suspicious account to prevent brute-force attacks while notifying the user and/or the security team.
Configuration Check: Automatically validate Identity Provider (IdP) settings and any recent policy changes that may be causing systemic login failures.

### 5. Policy Misconfigurations Detected

Trigger: A spike in blocked user actions or repeated policy warnings in a short period—often indicative of an overly restrictive firewall or proxy policy setting.

Automated Log Collection: The system gathers firewall logs, web proxy logs, and access control policy configuration data to pinpoint the conflicting or newly added policy rule.

Remediation Techniques:
Policy Rollback: If a recent configuration or update caused the issue, revert to a known-good policy version automatically.
Granular Policy Refinement: Suggest policy exceptions (e.g., whitelisting certain URLs or apps) based on log evidence showing legitimate access attempts.
Policy Simulation: Enable a simulation or “monitor-only” mode to observe the impact of policy changes before enforcing them.

### 6. Suspected Malware or Security Threat

Trigger: Endpoint detects unusual network traffic patterns, flagged by security modules or intrusion detection systems (e.g., repeated connection attempts to malicious domains).

Automated Log Collection: The system retrieves antivirus logs, intrusion detection logs, DNS queries, and firewall event logs for comprehensive analysis.

Remediation Techniques:
Containment Actions: Quarantine the affected endpoint, blocking all non-essential network traffic until sanitized.
Malware Scan & Clean: Trigger a full antivirus/anti-malware scan, automatically removing or isolating suspicious files.
Security Policy Update: Dynamically update network policies to block newly flagged malicious IP addresses or URLs enterprise-wide.

### 7. Abnormal Device Behavior or Configuration Drift

Trigger: A device deviates from its normal operational baseline—e.g., unauthorized software installed, suspicious service changes, or significant OS configuration changes detected by drift monitoring.

Automated Log Collection: Gather system event logs, registry or system configuration changes, and logs from monitoring agents that track device baseline metrics.

Remediation Techniques:
Baseline Rollback: Restore the device to its previously known-good configuration if the changes are unauthorized.
User Notification: Prompt the user to confirm intentional changes, if any, or open an automated escalation if changes appear malicious.
Policy Enforcement: Automatically enforce stricter controls on the device, limiting network access until the device's integrity is verified.
   How these Triggers and Remediations Fit into an Automated Workflow
1. Monitoring: The system continuously watches for specific events or metric thresholds across end user devices, network components, and applications.
2. Auto-Trigger for Logs: Once a trigger fires, the system immediately collects relevant logs—without waiting for manual requests—reducing Mean Time to Detect (MTTD).
3. Log Analysis & Insight: Automated analysis processes the logs (e.g., AI/ML-driven techniques or rule-based engines) to isolate potential root causes.
4. Recommended Action: If an issue is confirmed, the system automatically executes or recommends remediation to the help desk team or the end user, thereby reducing Mean Time to Resolve (MTTR).

By implementing these or similar triggers for automated log collection and tying them to well-defined remediation techniques, support systems can significantly expedite incident handling, streamline resolution workflows, and maintain an optimized user experience across the enterprise network.

### Processing Circuitry and Non-Transitory Computer-Readable Media

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. An automated client support system comprising:
an enterprise network monitoring unit configured to monitor an enterprise network;
an automatic data log retrieval unit configured to automatically collect data logs from the enterprise network in response to the enterprise network monitoring unit detecting one or more adverse conditions of the enterprise network that imply a decline in one or more User Experience (UX) metrics;
an automatic data log analysis unit configured to automatically analyze the data logs collected by the automatic data log retrieval unit; and
an insight/action generation unit configured to suggest one or more actions to remediate the one or more adverse conditions in response to the automatic data log analysis unit determining that the data logs indicate one or more issues in the enterprise network.

2. The automated client support system of claim 1, wherein the insight/action generation unit is further configured to generate one or more insights or recommendations to a help desk agent.

3. The automated client support system of claim 1, wherein, in response to the enterprise network monitoring unit detecting a decline in the one or more UX metrics or detecting one or more specific adverse conditions in the enterprise network, the enterprise network monitoring unit is configured to initiate a trigger signal that triggers the automatic data log retrieval unit to automatically collect the data logs.

4. The automated client support system of claim 1, wherein the enterprise network monitoring unit is configured to detect the one or more adverse conditions by monitoring device events of end user devices incorporated in the enterprise network.

5. The automated client support system of claim 1, wherein the automatic data log retrieval unit is configured to preemptively collect data logs before opening a service ticket.

6. The automated client support system of claim 1, wherein the insight/action generation unit is configured to provide the one or more actions as suggestions to a help desk agent for consideration.

7. The automated client support system of claim 1, wherein the enterprise network monitoring unit and automatic data log retrieval unit are configured to communicate with the enterprise network via a client connection interface.

8. The automated client support system of claim 1, wherein the automatic data log analysis unit is further configured to determine whether the one or more adverse conditions of the enterprise network are a root cause of the decline in the one or more UX metrics.

9. The automated client support system of claim 1, wherein the one or more adverse conditions include one or more of a) a drop in application performance with respect to one or more end user devices associated with the enterprise network, b) recurring connectivity issues with respect to the one or more end user devices, c) deviation of the one or more end user devices from normal device behavior.

10. The automated client support system of claim 1, wherein each data log has a depth that corresponds to a severity of an adverse condition of the enterprise network.

11. A method comprising steps of:
monitoring an enterprise network;
in response to detecting one or more adverse conditions of the enterprise network that imply a decline in one or more User Experience (UX) metrics, automatically collecting data logs from the enterprise network;
automatically analyzing the data logs; and
in response to determining that the data logs indicate one or more issues in the enterprise network, suggesting actions to remediate the one or more issues.

12. The method of claim 11, further comprising a step of generating one or more insights or recommendations for consideration by a help desk agent.

13. The method of claim 11, wherein the step of automatically collecting data logs is automatically triggered by a detected decline in the one or more UX metrics or specific adverse conditions in the enterprise network.

14. The method of claim 11, wherein an action of detecting for one or more adverse conditions of the enterprise network includes monitoring device events of one or more end user devices incorporated in the enterprise network.

15. The method of claim 11, further comprising a step of preemptively collecting data logs before opening a service ticket.

16. The method of claim 11, further comprising a step of determining whether the one or more adverse conditions of the enterprise network are a root cause of the decline in the one or more UX metrics.

17. The method of claim 11, wherein the one or more adverse conditions include one or more of a) a drop in application performance with respect to one or more end user devices associated with the enterprise network, b) recurring connectivity issues with respect to the one or more end user devices, c) deviation of the one or more end user devices from normal device behavior.

18. The method of claim 11, wherein each data log has a depth that corresponds to a severity of an adverse condition of the enterprise network.

19. A non-transitory computer-readable medium configured to store a ticketing program having instructions that enable a processing device to:
monitor an enterprise network;
in response to detecting one or more adverse conditions of the enterprise network that imply a decline in one or more User Experience (UX) metrics, automatically collect data logs from the enterprise network;
automatically analyze the data logs; and
in response to determining that the data logs indicate one or more issues in the enterprise network, suggest actions to remediate the one or more issues.

20. The non-transitory computer-readable medium of claim 19, wherein the instructions further enable the processing device to generate one or more insights or recommendations to a help desk agent.
